(19) United States
(12) Patent Application Publication
(10) Pub. No.: US 2026/0121162 A1
(43) Pub. Date: Apr. 30, 2026

(54) BATTERY ENCLOSURE WITH AIR FLOW CHANNEL FOR COOLING DURING THERMAL PROPAGATION

(71) Applicant: GM Global Technology Operations LLC, Detroit, MI (US)

(72) Inventors: Kothamasi Sumithra Raju, Bengaluru (IN); Derek Frei Lahr, Ann Arbor, MI (US); Xiaoling Chen, Sterling Heights, MI (US); Ronald O. Grover, JR., Northville, MI (US); Ashok Kumar Maruthai, Bengaluru (IN); Sudipto Ray, Bangalore (IN); SeungHwan Keum, Northville, MI (US)

(73) Assignee: GM Global Technology Operations LLC, Detroit, MI (US)

(21) Appl. No.: 18/925,927

(22) Filed: Oct. 24, 2024

(51) Int. Cl. H01M 10/6564; H01M 10/613; H01M 10/625; H01M 10/635; H01M 10/647; H01M 10/663; H01M 50/209; H01M 50/249; H01M 50/367

(52) U.S. Cl. CPC H01M 10/6564; H01M 10/613; H01M 10/625; H01M 10/635; H01M 10/647; H01M 10/663; H01M 50/209; H01M 50/249; H01M 50/367

(57) ABSTRACT

A system includes a prismatic battery assembly including an enclosure, an air flow inlet, an air flow outlet, an air flow channel, and a vent channel. The enclosure has a first end, a second end, a first side wall, and a second side wall. The air flow inlet is disposed at the first side wall, and the air flow outlet is disposed at the second side wall. The air flow channel extends within the enclosure between the air flow inlet and the air flow outlet. The vent channel has a gas vent inlet that is fluidically connected to the air flow channel. The system also includes an air flow source configured to direct air flow from the air flow inlet along the air flow channel and out the air flow outlet. The air flow draws heated vent gasses away from the prismatic battery assembly.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a prismatic battery assembly for a vehicle, and specifically, to thermal management of the prismatic battery assembly. During operation of the vehicle, the prismatic battery assembly may be configured to provide power and propulsion to the vehicle. The prismatic battery assembly generally includes one or more cells within an enclosure of the prismatic battery assembly. The one or more cells may generate heat in the form of vent gases during operation of the prismatic battery assembly. During instances of heat generation within the enclosure, such as during instances of thermal propagation, thermal management techniques applied at the prismatic battery assembly are configured to maintain suitable heat levels within the battery. However, it is desired to implement improvements to thermal management techniques to dissipate heat from the prismatic battery assembly in a quick and efficient manner.

### SUMMARY

One aspect of the disclosure provides a system. The system includes a prismatic battery assembly. The prismatic battery assembly includes an enclosure, an air flow inlet, an air flow outlet, an air flow channel, and a vent channel. The enclosure has a first end, a second end opposite the first end, a first side wall extending between the first end and the second end, and a second side wall opposite the first side wall and extending between the first end and the second end. The air flow inlet is disposed at the first side wall, and the air flow outlet is disposed at the second side wall. The air flow channel extends within the enclosure between the air flow inlet and the air flow outlet. The vent channel has a vent gas inlet that is fluidically connected to the air flow channel. The system also includes an air flow source. The air flow source, based on detecting thermal propagation of the prismatic battery assembly, directs air flow from the air flow inlet along the air flow channel and out the air flow outlet. The air flow draws heated vent gases from the vent gas inlet of the vent channel and away from the prismatic battery assembly.

Implementations of this aspect of the disclosure may include one or more of the following optional features. In some examples, the vent channel extends within the enclosure between the first end and the vent gas inlet at the air flow channel.

In some implementations, the air flow between the air flow inlet and the air flow outlet along the air flow channel forms an air curtain between the vent gas inlet and a component of the prismatic battery assembly.

In some configurations, the air flow source is operated to adjust the air flow based on a determined temperature of the prismatic battery assembly.

In some examples, the air flow source includes at least one selected from the group consisting of i) an air conditioning blower of a heating, ventilation and air conditioning (HVAC) system of a vehicle that provides cooled air flow to the prismatic battery assembly, and ii) an air flow compressor that provides ambient air flow to the prismatic battery assembly. In some further examples, a control valve is disposed between the air conditioning blower and the air flow inlet. The control valve adjusts cooled air flow from the air conditioning blower from being directed toward an interior cabin of the vehicle to being directed toward the air flow inlet based on detecting thermal propagation. In some other further examples, the air flow compressor provides ambient air flow to the prismatic battery assembly based on determination that the ambient air flow has a humidity level below a threshold level of humidity, and the air conditioning blower provides cooled air flow to the prismatic battery assembly based on determination that the ambient air flow has a humidity level above the threshold level of humidity. In some other even further examples, the HVAC system includes a humidity regulator for adjusting a humidity level of the cooled air flow.

In some implementations, the air flow source is disposed upstream of the air flow inlet and directs the air flow into the air flow inlet.

In some configurations, the air flow source is disposed downstream of the air flow outlet and draws the air flow through the air flow outlet.

In some examples, the air flow source directs the air flow and a fire-retardant agent along the air flow channel.

In some implementations, the air flow source includes an oxygen reduction device that reduces oxygen levels of the air flow from ambient air.

Another aspect of the disclosure provides a vehicle. The vehicle includes a prismatic battery assembly. The prismatic battery assembly includes an enclosure, an air flow inlet, an air flow outlet, an air flow channel, and a vent channel. The enclosure has a first end, a second end opposite the first end, a first side wall extending between the first end and the second end, and a second side wall opposite the first side wall and extending between the first end and the second end. The air flow inlet is disposed at the first side wall, and the air flow outlet is disposed at the second side wall. The air flow channel extends within the enclosure between the air flow inlet and the air flow outlet. The vent channel has a vent gas inlet that is fluidically connected to the air flow channel. The vehicle also includes an air flow source. The air flow source, based on detecting thermal propagation of the prismatic battery assembly, directs air flow from the air flow inlet along the air flow channel and out the air flow outlet. The air flow draws heated vent gases from the vent gas inlet of the vent channel and away from the prismatic battery assembly.

Implementations of this aspect of the disclosure may include one or more of the following optional features. In some examples, the air flow source includes at least one selected from the group consisting of i) an air conditioning blower of a heating, ventilation and air conditioning (HVAC) system of a vehicle that provides cooled air flow to the prismatic battery assembly, and ii) an air flow compressor that provides ambient air flow to the prismatic battery assembly.

In some implementations, the air flow source is disposed upstream of the air flow inlet and directs the air flow into the air flow inlet.

In some configurations, the air flow source is disposed downstream of the air flow outlet and draws the air flow through the air flow outlet.

Yet another aspect of the disclosure provides a prismatic battery assembly. The prismatic battery assembly includes an enclosure, an air flow inlet, an air flow outlet, an air flow channel, and a vent channel. The enclosure has a first end, a second end opposite the first end, a first side wall extending between the first end and the second end, and a second side wall opposite the first side wall and extending between the first end and the second end. The air flow inlet is disposed at the first side wall, and the air flow outlet is disposed at the second side wall. The air flow channel extends within the enclosure between the air flow inlet and the air flow outlet. The vent channel has a vent gas inlet that is fluidically connected to the air flow channel, wherein, based on detecting thermal propagation of the prismatic battery assembly, an air flow source directs air flow from the air flow inlet along the air flow channel and out the air flow outlet. The air flow draws heated vent gases from the vent gas inlet of the vent channel and away from the prismatic battery assembly.

Implementations of this aspect of the disclosure may include one or more of the following optional features. In some examples, the air flow source includes at least one selected from the group consisting of i) an air conditioning blower of a heating, ventilation and air conditioning (HVAC) system of a vehicle that provides cooled air flow to the prismatic battery assembly, and ii) an air flow compressor that provides ambient air flow to the prismatic battery assembly.

In some implementations, the air flow source is disposed upstream of the air flow inlet and directs the air flow into the air flow inlet.

In some configurations, the air flow source is disposed downstream of the air flow outlet and draws the air flow through the air flow outlet.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a prismatic battery assembly and an air flow source according to the present disclosure;

FIG. 2 is a sectional view of a prismatic battery assembly according to the present disclosure;

FIG. 3 is a side-view of an air flow source according to the present disclosure including a flow-chart of operations of the air flow source;

FIG. 4 is a side-view of an air flow source according to the present disclosure including a flow-chart of operations of the air flow source;

FIG. 5A is a schematic of the prismatic battery assembly of FIG. 2;

FIG. 5B is a schematic of the prismatic battery assembly of FIG. 2 including a temperature gradient during non-operation of an air flow source;

FIG. 5C is a schematic of the prismatic battery assembly of FIG. 2 including a temperature gradient during operation of an air flow source;

FIG. 6 is a sectional view of the prismatic battery assembly of FIG. 2 including an air flow source downstream of an air flow inlet of the prismatic battery assembly;

FIG. 7 is a sectional view of the prismatic battery assembly of FIG. 2 including an air flow source upstream of an air flow inlet of the prismatic battery assembly and including a fire-retardant agent;

FIG. 8 is a close-up of an air flow inlet of the prismatic battery assembly of FIG. 2;

FIG. 9 is a flow-chart of operations of a prismatic battery assembly and an air flow source according to the present disclosure; and

FIG. 10 is a flow-chart of operations of a prismatic battery assembly and an air flow source according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

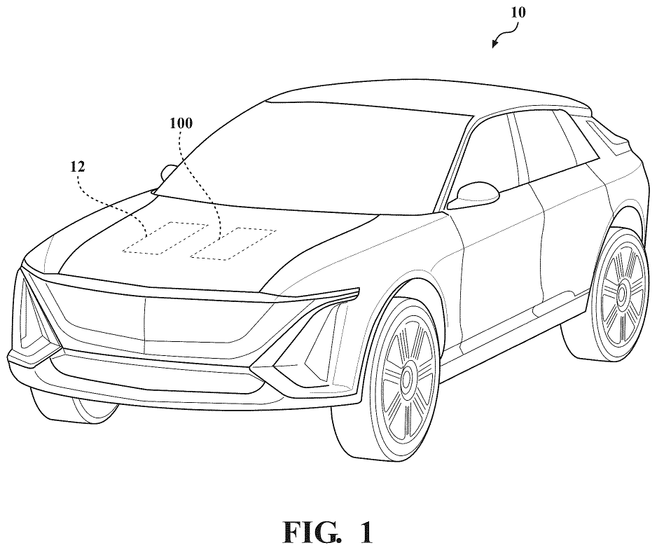

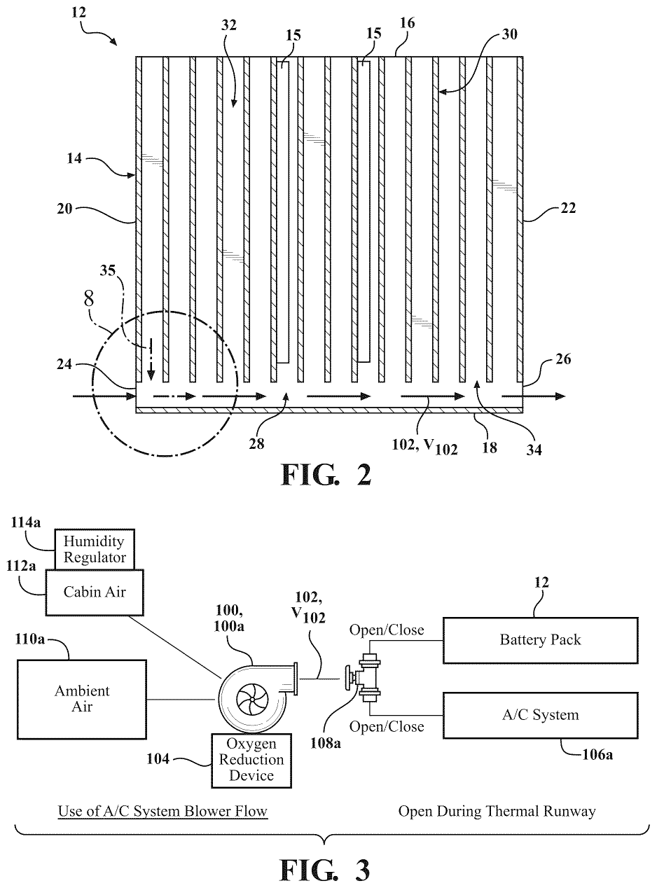

With reference to FIGS. 1-3, a vehicle or system 10 includes a prismatic battery assembly 12 and an air flow source 100. As discussed further below, the air flow source 100 generates and directs air flow 102 within an enclosure 14 of the prismatic battery assembly 12 during thermal propagation. In many instances, thermal propagation causes increased temperatures and pressures within the prismatic battery assembly 12, which may result in thermal propagation at the prismatic battery assembly 12 and hinder its intended operation. The air flow source 100 offers a means to cool and reduce the temperature of the prismatic battery assembly 12 during thermal propagation and thus reduces the potential for operational hinderance to both the prismatic battery assembly 12 and the vehicle 10. Furthermore, the cooling capabilities offered by the air flow source 100 may increase the lifespan and overall longevity of the prismatic battery assembly 12.

The prismatic battery assembly 12 includes the enclosure 14 that houses one or more internal components 15 of the prismatic battery assembly 12, such as one or more cells, thermal barriers, heat dissipating elements (e.g., heat dissipating fins), and the like. Many of the one or more internal components 15 generate heat, or may be negatively affected by excessive heat, during operation of the prismatic battery assembly 12 and during thermal propagation. In the illustrated example, the enclosure 14 includes a first end wall 16 and a second end wall 18 opposite the first end wall 16. The enclosure 14 also includes a first side wall 20 extending between the first end wall 16 and the second end wall 18, and a second side wall 22 opposite the first side wall 20 and extending between the first end wall 16 and the second end wall 18. When equipped at the vehicle 10, the first end wall 16 and the second end wall 18 may respectively define top and bottom surfaces or horizontally extending sides of the enclosure 14 and the first side wall 20 and the second side wall 22 may respectively define side surfaces or vertically extending sides of the enclosure 14. Although shown as having a generally cube-shaped or box-shaped enclosure 14, it should be understood that characteristics of the prismatic battery assembly 12 described herein may be applicable to battery assemblies having any suitably shaped enclosure, such as a cylindrical enclosure and the like.

An air flow inlet 24 is disposed at the first side wall 20, and an air flow outlet 26 is disposed at the second side wall 22. The air flow inlet 24 includes an aperture or channel or passageway formed through the first side wall 20 and that fluidically connects an interior portion of the enclosure 14 to exterior of the enclosure 14. Similarly, the air flow outlet 26 includes an aperture or channel or passageway formed through the second side wall 22 that fluidically connects the interior portion of the enclosure 14 to exterior of the enclosure 14. An air flow channel 28 extends within the enclosure 14 between the air flow inlet 24 and the air flow outlet 26. The air flow channel 28 accommodates air flow 102 that travels in the direction from the air flow inlet 24 toward the air flow outlet 26 during operation of the air flow source 100.

As shown, the air flow inlet 24, the air flow outlet 26, and the air flow channel 28 are positioned in close proximity to the second end wall 18 of the enclosure 14. That is, in the illustrated example, the air flow inlet 24 and the air flow outlet 26 are formed through the first side wall 20 and the second side wall 22 near the second end wall 18 and the air flow channel 28 extends along an interior surface of the second end wall 18 within the enclosure 14. Thus, the air flow channel 28 may extend along a lower portion or bottom region of the interior of the enclosure 14. It should be understood that the positioning of the air flow inlet 24, the air flow outlet 26, and the air flow channel 28 described herein may be positioned closer to the first end wall 16, closer to the second end wall 18, or positioned equidistant between the first end wall 16 and the second end wall 18, depending on the configuration of the enclosure 14.

The air flow inlet 24 and/or the air flow outlet 26 may be covered or closed or blocked, such as during regular operation of the prismatic battery assembly 12 when thermal propagation is not occurring, and the air flow inlet 24 and/or the air flow outlet 26 may be uncovered or opened during thermal propagation. Optionally, the air flow inlet 24 and the air flow outlet 26 may remain unobstructed regardless of operations of the air flow source 100 and regardless of whether thermal propagation is present.

The prismatic battery assembly 12 also includes structure 30 defining one or more vent channels 32 disposed within the enclosure 14. For example, the structure 30 may be proximate to the one or more internal components 15 of the prismatic battery assembly 12. While many of the one or more internal components 15 are configured to dissipate heat, or do not contribute to heat generation, many of the one or more internal components 15 may generate heat within the one or more vent channels 32 during operation of the prismatic battery assembly 12, as stated above. In the illustrated example, the structures 30 extend from the first end wall 16 toward the second end wall 18 and generally parallel to the first side wall 20 and the second side wall 22. Each of the one or more vent channels 32 extends between adjacent structures 30, with the structures 30 separating adjacent vent channels 32 if the prismatic battery assembly 12 includes at least two of the one or more vent channels 32. A vent gas inlet 34 is included with each of the vent channels 32 and are positioned at distal ends of the structures 30 opposite the first end wall 16. Each of the vent gas inlets 34 are spaced from the second end wall 18 so that each of the vent gas inlets 34 intersect the air flow channel 28. Thus, the one or more vent channels 32 are fluidically connected to the air flow channel 28 via the vent gas inlets 34 and may accommodate the flow of vent gases 35, which may be heated, along the one or more vent channels 32 into the air flow channel 28. For example, during thermal propagation, the vent gases 35 generated at the one or more internal components 15, such as within the cells of the prismatic battery assembly 12, travel into and along the one or more vent channels 32, through the vent gas inlets 34, and into the air flow channel 28.

Referring to FIG. 3, the vehicle 10 includes the air flow source 100 that is configured to generate and direct the air flow 102 through the air flow channel 28 of the prismatic battery assembly 12 during thermal propagation. The air flow source 100 may be operated to generate the air flow 102 based on detecting thermal propagation, such as based on determination of a temperature at the prismatic battery assembly 12 that is above a threshold temperature level. During operation of the air flow source 100, the air flow source 100 directs the air flow 102 from the air flow inlet 24, along the air flow channel 28, and out the air flow outlet 26.

The air flow 102 draws heat from the one or more vent channels 32 via the vent gas inlet 34, along the air flow channel 28, and out the air flow outlet 26 away from the prismatic battery assembly 12. For example, the vent gases 35 generated during thermal propagation are carried toward the air flow outlet 26 by the air flow 102, relieving the prismatic battery assembly 12 of heat and pressure. In other words, as the vent gases 35, which are heated from operation of the one or more internal components 15, or heated from thermal propagation, travel from the one or more vent channels 32 into the air flow channel 28, the vent gases 35 are met with the air flow 102 traveling from the air flow inlet 24 toward the air flow outlet 26. The vent gases 35 may mix with the air flow 102 at the air flow channel 28. Further, the reduced temperature of the air flow 102 may cool the enclosure 14 as the air flow 102 replaces the vent gases 35. This allows the system to regulate the temperature of the prismatic battery assembly 12 during thermal propagation. Furthermore, the air flow inlet 24 and/or the air flow outlet 26 enable the prismatic battery assembly 12 to regulate its pressure during thermal propagation. In other words, because the enclosure 14 is not fully sealed due to the air flow inlet 24 and the air flow outlet 26, pressure within the enclosure 14 is prevented from exceeding excessively high levels.

The air flow 102 between the air flow inlet 24 and the air flow outlet 26 along the air flow channel 28 forms an air curtain 36 between the vent gas inlet 34 and the one or more internal components 15 of the prismatic battery assembly 12. The air curtain 36 prevents the one or more internal components 15 from becoming negatively affected due to a buildup of heat from the vent gases 35. As heat from the vent gases 35 escapes the one or more vent channels 32 via the vent gas inlet 34, the air curtain 36 formed from the air flow 102 prevents the vent gases 35 and associated heat from re-entering the one or more vent channels 32.

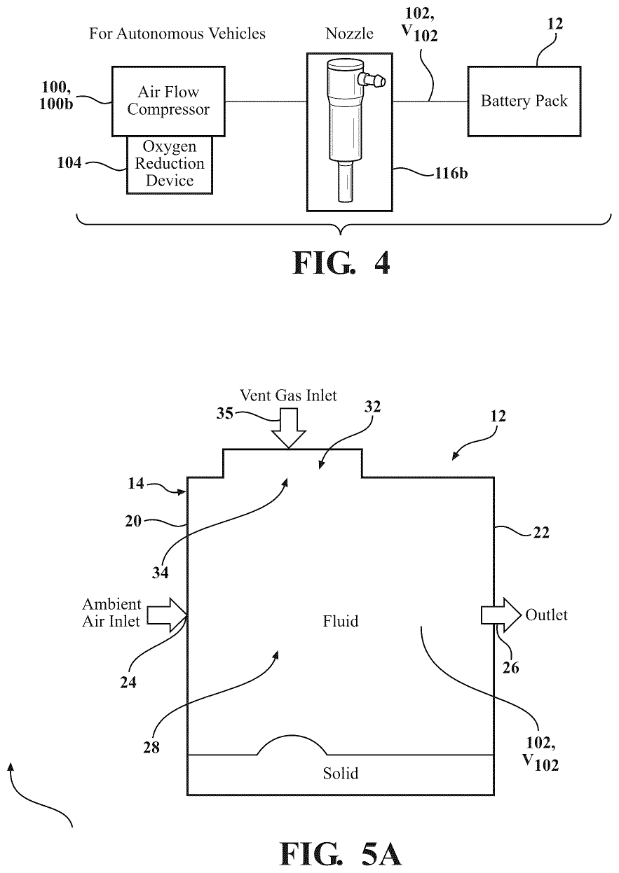

As shown in FIGS. 3 and 4, during operation of the air flow source 100, ambient air 110a may be pressurized or directed as the air flow 102 toward the prismatic battery assembly 12. As discussed further below, conditions and make-up of the air flow 102 may be adjusted based on the operation of the prismatic battery assembly 12 and/or the condition of thermal propagation. For example, operation of the air flow source 100 may adjust a velocity V₁₀₂ of the air flow 102, an oxygen content of the air flow 102, a humidity of the air flow 102, and the like.

The air flow 102 may be adjusted based on a determined temperature of the prismatic battery assembly 12. For example, operation of the air flow source 100 may vary the velocity V₁₀₂ of the air flow 102 based at least in part on the temperature of the prismatic battery assembly 12. In other words, the air flow 102 may have a relatively high velocity V₁₀₂ based on detecting a relatively high temperature of the prismatic battery assembly 12 indicative of thermal propagation, and the air flow 102 may have a relatively low velocity V₁₀₂ based on detecting a relatively lower temperature of the prismatic battery assembly 12, such as during regular operation of the prismatic battery assembly 12. Varying the velocity V₁₀₂ of the air flow 102 allows the air flow source 100 to efficiently and effectively cool the prismatic battery assembly 12 based on its current temperature.

In some examples, as seen in FIGS. 3 and 4, the air flow source 100 may include an oxygen reduction device 104. Because the air flow source 100 may draw ambient air 110a to generate the air flow 102, the oxygen reduction device 104 reduces or eliminates an oxygen content or oxygen level of the air flow 102 to ensure that the air flow 102 does not contain atmospheric levels of oxygen. As a result, the potential for sparks or fires within the prismatic battery assembly 12 during thermal propagation is reduced. The air flow source 100 may include other filters for reducing or eliminating other combustible materials or elements from the air flow 102.

Multiple configurations of the air flow source 100 may be provided without deviating from the context of this disclosure. For example, and with particular reference to FIG. 3, the air flow source 100 includes an air conditioning blower 100a of a heating, ventilation, and air conditioning (HVAC) system 106a of the vehicle 10. The air conditioning blower 100a is positioned upstream of the air flow inlet 24 and is operable to generate the air flow 102 and direct it along the air flow channel 28 of the prismatic battery assembly 12. A control valve 108a is disposed between the air conditioning blower 100a and the air flow inlet 24. The control valve 108a is adjustable between the air flow 102 to the HVAC system 106a (e.g., to cool the interior cabin of the vehicle) and to the prismatic battery assembly 12. In some examples, the control valve 108a may include a third position for directing or splitting the air flow 102 between both the HVAC system 106a and the prismatic battery assembly 12.

During operation of the air conditioning blower 100a, the air conditioning blower 100a draws ambient air 110a or cabin air 112a and generates and directs the air flow 102 toward the control valve 108a at velocity V₁₀₂. Furthermore, the air conditioning blower 100a may chill the air flow 102 to provide better cooling capabilities to the prismatic battery assembly 12. Determining whether ambient air 110a or cabin air 112a is provided to the air conditioning blower 100a may depend on a humidity level of the ambient air. If the vehicle 10 detects a relatively high level of humidity in the ambient air 110a, the air conditioning blower 100a will draw the cabin air 112a. A humidity regulator 114a may be integrated with the cabin air 112a as to regulate and maintain lower levels of humidity in the cabin air 112a compared to humidity levels in the ambient air 110a. As a result, the air flow 102 that eventually reaches the prismatic battery assembly 12 will have a humidity level that is less than the humidity level of the ambient air 110a.

If the air flow 102 has a level of humidity that is excessively high, the air flow 102 may cause negative effects or increased wear to the prismatic battery assembly 12 due to potential arcing. Therefore, regulating and maintaining relatively low levels of humidity in the air flow 102 is desired for longevity and effectiveness of the prismatic battery assembly 12. If the vehicle 10 detects a relatively low level of humidity in the ambient air 110a, the air conditioning blower 100a will draw the ambient air 110a, as humidity regulation from the humidity regulator 114a and the cabin air 112a is not necessary. Furthermore, optionally and as stated above, the oxygen reduction device 104 may be incorporated into the air conditioning blower 100a to regulate the levels of oxygen in the air flow 102.

The air conditioning blower 100a, the control valve 108a, the prismatic battery assembly 12, and the HVAC system 106a may be connected by any suitable conduit or air flow connection. The control valve 108a is operated to adjust direction of the air flow 102 toward its intended target. Based on the prismatic battery assembly 12 not experiencing thermal propagation, and the prismatic battery assembly 12 operating at normal temperatures, the control valve 108a may direct the entirety of the air flow 102 to the HVAC system 106a and an interior cabin of the vehicle 10. Based on the prismatic battery assembly 12 experiencing thermal propagation, the control valve 108a may direct a portion or the entirety of the air flow 102 toward the air flow inlet 24, along the air flow channel 28 within the enclosure 14, and out the air flow outlet 26 to cool the prismatic battery assembly 12. Optionally, the proportion of the air flow 102 directed to the prismatic battery assembly 12 may be adjusted based on the severity of thermal propagation, the temperature of the prismatic battery assembly 12, or the user settings of the HVAC system 106a. The control valve 108a may continuously adjust the direction of the air flow 102 based on current conditions of both the HVAC system 106a and the prismatic battery assembly 12.

In some examples, and with particular reference to FIG. 4, the air flow source 100 includes an air flow compressor 100b. In view of the substantial similarity in structure and function of the components associated with the air flow source 100, like reference numerals are used hereinafter and in the drawings to identify like components while like reference numerals containing letter and number extensions are used to identify those components that have been modified.

The air flow compressor 100b is positioned upstream of the air flow inlet 24 and is operable to generate the air flow 102 and direct it along the air flow channel 28 of the prismatic battery assembly 12. A nozzle 116b is disposed between the air flow compressor 100b and the air flow inlet 24. During operation of the air flow compressor 100b, the air flow compressor 100b generates and directs the air flow 102 toward the nozzle 116b. The air flow compressor 100b may chill the air flow 102 to provide better cooling capabilities to the prismatic battery assembly 12. Furthermore, optionally and as stated above, the oxygen reduction device 104 may be incorporated into the air conditioning blower 100a to regulate the levels of oxygen in the air flow 102.

The air flow compressor 100b, the nozzle 116b, and the prismatic battery assembly 12 may be connected by any suitable conduit or air flow connection. The nozzle 116b is operable to control the velocity V₁₀₂ of the air flow 102 as well as direct the air flow 102 to its intended target. Based on the prismatic battery assembly 12 not experiencing thermal propagation, and the prismatic battery assembly 12 operating at normal temperatures, the nozzle 116b may direct the entirety of the air flow 102 to an interior cabin of the vehicle 10. Based on the prismatic battery assembly 12 experiencing thermal propagation, the nozzle 116b may direct a portion or the entirety of the air flow 102 toward the air flow inlet 24, along the air flow channel 28 within the enclosure 14, and out the air flow outlet 26 to cool the prismatic battery assembly 12. Optionally, the proportion of the air flow 102 directed to the prismatic battery assembly 12 may be adjusted based on the severity of thermal propagation, the temperature of the prismatic battery assembly 12, or the user settings of the vehicle 10, such as to control the air flow 102 into the interior cabin of the vehicle 10. The nozzle 116b may continuously adjust the direction of the air flow 102 based on current conditions of the vehicle 10, including the current conditions of the prismatic battery assembly 12.

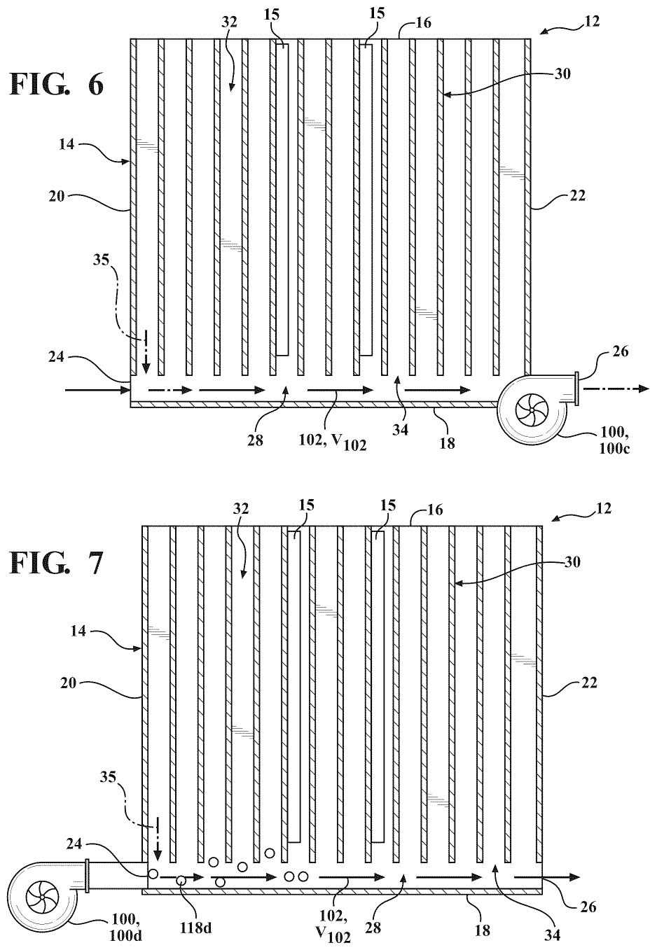

In some examples, and with particular reference to FIG. 6, the air flow source 100 includes an air conditioning blower 100c positioned downstream of the air flow channel 28. In view of the substantial similarity in structure and function of the components associated with the air flow source 100, like reference numerals are used hereinafter and in the drawings to identify like components while like reference numerals containing letter and number extensions are used to identify those components that have been modified.

The air conditioning blower 100c is positioned downstream of the air flow channel 28 and is operable to generate the air flow 102 and direct it along the air flow channel 28 of the prismatic battery assembly 12. In this regard, the air conditioning blower 100c may be positioned at or near the air flow outlet 26. During operation of the air conditioning blower 100c, the air conditioning blower 100c generates and directs the air flow 102 by drawing it through the air flow outlet 26. A vacuum created within the enclosure 14 by the air conditioning blower 100c draws the air flow 102 through the air flow inlet 24, along the air flow channel 28, and out the air flow outlet 26 where the air flow 102 finally reaches the air conditioning blower 100c. The vent gases 35 generated within the one or more vent channels 32 travel into the air flow channel 28, where the vent gases meet the air flow 102. As a result, the vent gases 35 cool and exit the enclosure 14 through the air flow outlet 26, thus regulating the temperature and pressure of the prismatic battery assembly 12.

In some examples, and with particular reference to FIG. 7, the air flow source 100 includes an air conditioning blower 100d that provides a fire-retardant agent 118d within the air flow 102. In view of the substantial similarity in structure and function of the components associated with the air flow source 100, like reference numerals are used hereinafter and in the drawings to identify like components while like reference numerals containing letter and number extensions are used to identify those components that have been modified.

The air conditioning blower 100d is positioned upstream of the air flow inlet 24 and is operable to generate the air flow 102 and direct it along the air flow channel 28 of the prismatic battery assembly 12. During operation of the air conditioning blower 100d, the air conditioning blower 100a draws ambient air or cabin air and generates and directs the air flow 102 toward the air flow inlet 24. Furthermore, the air conditioning blower 100d may chill the air flow 102 to provide better cooling capabilities to the prismatic battery assembly 12. The air conditioning blower 100d may introduce the fire-retardant agent 118d to the air flow 102 when the air conditioning blower 100d generates the air flow 102. In this regard, the air flow 102 and fire-retardant agent 118d are mixed together before they are introduced to the prismatic battery assembly 12. The fire-retardant agent 118d reduces the potential for sparks or fires within the prismatic battery assembly 12 during thermal propagation. The fire-retardant agent 118d may be glass beads, K2CO3, or something of the like.

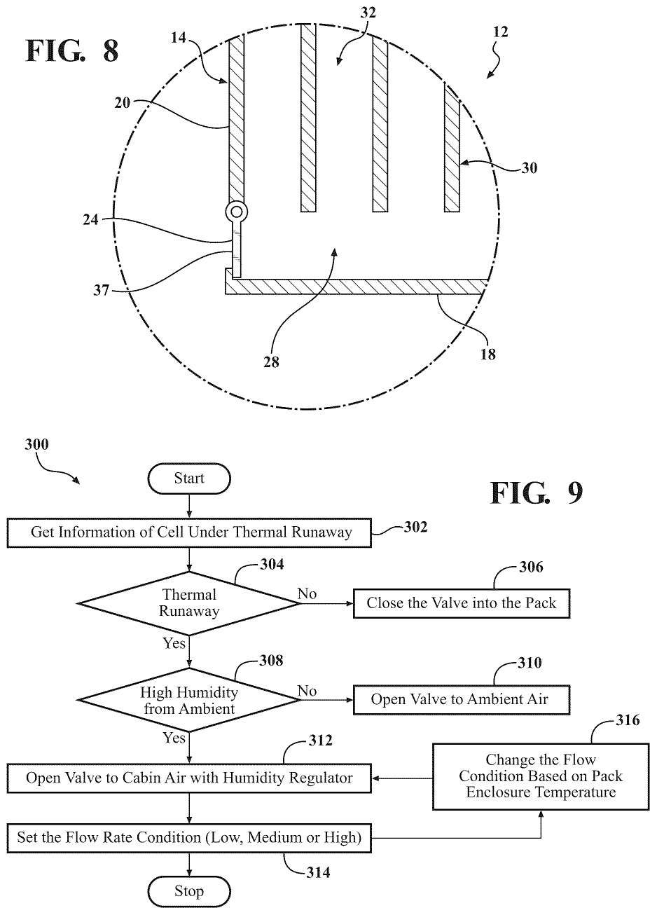

In some examples, and with particular reference to FIG. 8, prismatic battery assembly 12 includes an inlet flap 37 positioned at the air flow inlet 24. The inlet flap 37 may be hinged or connected to the enclosure 14 using any means that allows for the opening and closing of the inlet flap 37. The inlet flap 37 is unidirectional and configured to permit the air flow 102 from the air flow source 100 into the enclosure 14 while simultaneously preventing the air flow 102 from exiting the enclosure 14 at the inlet flap 37. During operation, the inlet flap 37 may be forced open due to the velocity V₁₀₂ of the air flow 102 entering the air flow inlet 24 and traveling through the air flow channel 28. For example, when the air flow travels from the air flow source 100 to the air flow inlet 24, the inlet flap 37 may hinge to provide an unobstructed path for the air flow 102 to travel along the air flow channel 28. In a similar manner, when air flow 102 ceases flowing along the air flow channel 28, the inlet flap 37 may close and seal the air flow inlet 24. Sealing the air flow inlet 24 via the inlet flap 37 prevents debris or toxic materials from exiting the prismatic battery assembly 12 and inadvertently entering the ambient environment outside the enclosure 14 of the prismatic battery assembly 12.

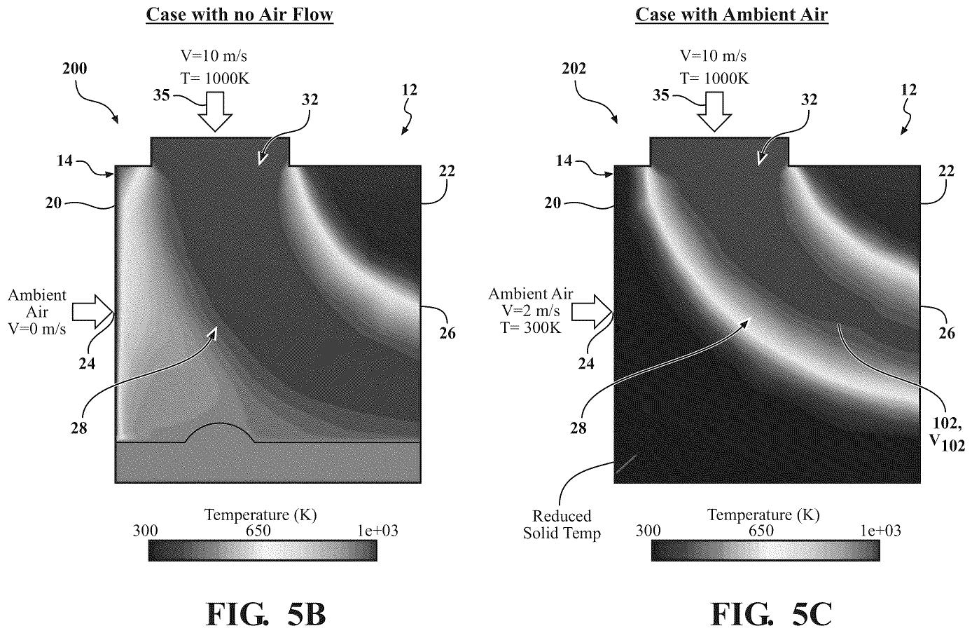

With reference to FIGS. 5A-5C, the velocity V₁₀₂ of the air flow 102 entering the air flow inlet 24, traveling along the air flow channel 28, and exiting through the air flow outlet 26 offers enhanced cooling to the prismatic battery assembly 12 compared to a scenario where the prismatic battery assembly 12 is free of the air flow 102. At 200, the prismatic battery assembly 12 is free of air flow 102 traveling along the air flow channel 28. During operation of the prismatic battery assembly 12, heat generated within the enclosure 14 is unencumbered to spread throughout the enclosure 14. The heat within the enclosure 14 is due to the vent gases 35 traveling through the vent channels 32 at temperatures of 1000 Kelvin. While heat from the vent gases 35 may still travel out of the enclosure 14 through the air flow outlet 26, the lack of air flow 102 prevents directed and intentional dissipation of heat out of the enclosure 14. As a result, the enclosure 14, as well as various components of the prismatic battery assembly 12 housed within the enclosure 14, may experience an excessive amount of heat that is not quickly dissipated. For example, the enclosure 14 may reach temperatures that exceed 650 Kelvin. This could lead to increased deterioration and a reduced lifespan of the prismatic battery assembly 12.

In contrast, at 202, the air flow 102 travels along the air flow channel 28 with the velocity V₁₀₂ of the air flow 102 at 2 meters per second. During operation of the prismatic battery assembly 12, the vent gases 35 travel through the vent channels 32 at temperatures of 1000 Kelvin. When the vent gases 35 pass through the vent gas inlet 34 and reach the air flow channel 28, the vent gases are met with the air flow 102 traveling in the direction from the air flow inlet 24 toward the air flow outlet 26. The velocity V₁₀₂ of the air flow 102 provides directed and intentional dissipation of heat out of the enclosure 14. As a result, the enclosure 14, as well as various components of the prismatic battery assembly 12 housed within the enclosure 14, benefit from temperature regulation. In other words, the air flow 102 maintains temperatures of the prismatic battery assembly 12 at a relatively cool. For example, the enclosure 14 may only reach temperatures near 300 Kelvin. This could increase longevity and ensure proper operation of the prismatic battery assembly 12.

With reference to FIG. 9, a thermal management method 300 associated with the embodiment as shown in FIG. 3 begins, at operation 302, with the vehicle 10 receiving information from the prismatic battery assembly 12, such as temperature and pressure. In this regard, at 304, it can be determined if the prismatic battery assembly 12 is experiencing thermal propagation. If no thermal propagation is present, at 306 of the thermal management method 300, the control valve 108a closes the pathway between the air conditioning blower 100a and the prismatic battery assembly 12. As a result, the air flow 102 is prevented from traveling between the air conditioning blower 100a and the prismatic battery assembly 12. However, if thermal propagation is detected, at 308, the vehicle 10 determines the humidity level of the ambient air 110a. If the ambient air 110a is determined to have relatively low levels of humidity, at 310, the air conditioning blower 100a draws from the ambient air 110a. If the ambient air 110a is determined to have relatively high levels of humidity, at 312, the air conditioning blower 100a draws from the cabin air 112a with humidity regulation via the humidity regulator 114a. At 314 of the thermal management method 300, the velocity V₁₀₂ of the air flow 102 is set to low velocity, medium velocity, or high velocity. The velocity V₁₀₂ of the air flow 102 may be set to high velocity when the prismatic battery assembly 12 experiences excessively high temperatures. Alternatively, the velocity V₁₀₂ of the air flow 102 may be set to low velocity when the prismatic battery assembly 12 experiences relatively low or moderate temperatures. At 316, the velocity V₁₀₂ of the air flow 102 is continuously adjusted based on changing temperatures at the prismatic battery assembly 12. The air flow 102 continues along the air flow channel 28, via the air conditioning blower 100a, until conditions of the prismatic battery assembly 12 no longer require active cooling from the air flow 102.

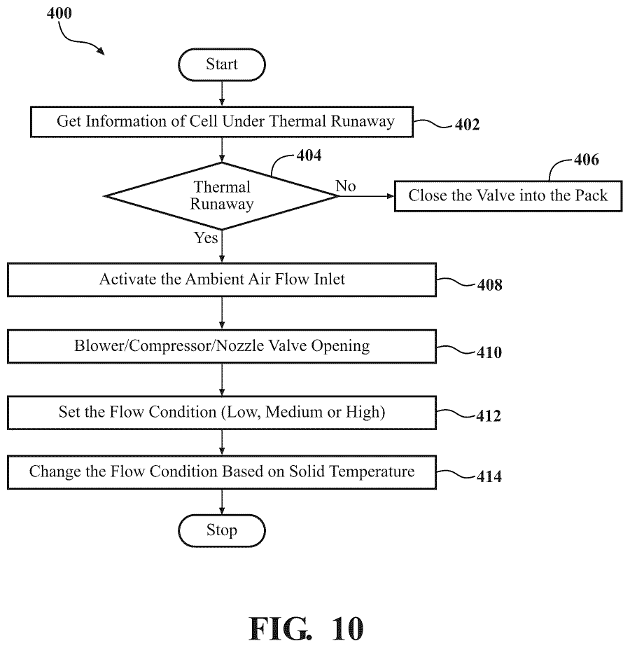

With reference to FIG. 10, a thermal management method 400 associated with the embodiments as shown in FIG. 4 and FIG. 8 begins, at operation 402, with the vehicle 10 receiving information from the prismatic battery assembly 12, such as temperature and pressure. In this regard, at 404, it can be determined if the prismatic battery assembly 12 is experiencing thermal propagation. If no thermal propagation is present, at 406 of the thermal management method 400, the air flow compressor 100b or the nozzle 116b closes the pathway between the air flow compressor 100b and the prismatic battery assembly 12. As a result, the air flow 102 is prevented from traveling between the air flow compressor 100b and the prismatic battery assembly 12. However, if thermal propagation is detected, at 408, the inlet flap 38 is opened at the enclosure 14. The inlet flap 38 may be electrically operated to open or, alternatively, may open as a result of the velocity V₁₀₂ of the air flow 102 at the air flow inlet 24.

At 410 of the thermal management method 400, the air flow compressor 100b, the nozzle 116b, or both the air flow compressor 100b and the nozzle 116 begin to generate and direct the air flow 102 toward the air flow inlet 24 and along the air flow channel 28. At 412 of the thermal management method 400, the velocity V₁₀₂ of the air flow 102 is set to low velocity, medium velocity, or high velocity. The velocity V₁₀₂ of the air flow 102 may be set to high velocity when the prismatic battery assembly 12 experiences excessively high temperatures. Alternatively, the velocity V₁₀₂ of the air flow 102 may be set to low velocity when the prismatic battery assembly 12 experiences relatively low or moderate temperatures. At 414, the velocity V₁₀₂ of the air flow 102 is continuously adjusted based on changing temperatures at the prismatic battery assembly 12. The air flow 102 continues along the air flow channel 28, via the air flow compressor 100b, until conditions of the prismatic battery assembly 12 no longer require active cooling from the air flow 102.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system comprising:
a prismatic battery assembly including:
an enclosure having a first end, a second end opposite the first end, a first side wall extending between the first end and the second end, and a second side wall opposite the first side wall and extending between the first end and the second end;
an air flow inlet disposed at the first side wall;
an air flow outlet disposed at the second side wall;
an air flow channel extending within the enclosure between the air flow inlet and the air flow outlet; and
a vent channel having a vent gas inlet that is fluidically connected to the air flow channel; and
an air flow source, the air flow source, based on detecting thermal propagation of the prismatic battery assembly, directing air flow from the air flow inlet along the air flow channel and out the air flow outlet, the air flow drawing heated vent gasses from the vent gas inlet of the vent channel and away from the prismatic battery assembly.

2. The system of claim 1, wherein the vent channel extends within the enclosure between the first end and the vent gas inlet at the air flow channel.

3. The system of claim 1, wherein the air flow between the air flow inlet and the air flow outlet along the air flow channel forms an air curtain between the vent gas inlet and a component of the prismatic battery assembly.

4. The system of claim 1, wherein the air flow source is operated to adjust the air flow based on a determined temperature of the prismatic battery assembly.

5. The system of claim 1, wherein the air flow source includes at least one selected from the group consisting of i) an air conditioning blower of a heating, ventilation and air conditioning (HVAC) system of a vehicle that provides cooled air flow to the prismatic battery assembly, and ii) an air flow compressor that provides ambient air flow to the prismatic battery assembly.

6. The system of claim 5, wherein a control valve is disposed between the air conditioning blower and the air flow inlet, the control valve adjusting cooled air flow from the air conditioning blower from being directed toward an interior cabin of the vehicle to being directed toward the air flow inlet based on detecting thermal propagation.

7. The system of claim 5, wherein the air flow compressor provides ambient air flow to the prismatic battery assembly based on determination that the ambient air flow has a humidity level below a threshold level of humidity, and the air conditioning blower provides cooled air flow to the prismatic battery assembly based on determination that the ambient air flow has a humidity level above the threshold level of humidity.

8. The system of claim 7, wherein the HVAC system includes a humidity regulator for adjusting a humidity level of the cooled air flow.

9. The system of claim 1, wherein the air flow source is disposed upstream of the air flow inlet and directs the air flow into the air flow inlet.

10. The system of claim 1, wherein the air flow source is disposed downstream of the air flow outlet and draws the air flow through the air flow outlet.

11. The system of claim 1, wherein the air flow source directs the air flow and a fire-retardant agent along the air flow channel.

12. The system of claim 1, wherein the air flow source includes an oxygen reduction device that reduces oxygen levels of the air flow from ambient air.

13. A vehicle comprising:
a prismatic battery assembly including:
an enclosure having a first end, a second end opposite the first end, a first side wall extending between the first end and the second end, and a second side wall opposite the first side wall and extending between the first end and the second end;
an air flow inlet disposed at the first side wall;
an air flow outlet disposed at the second side wall;
an air flow channel extending within the enclosure between the air flow inlet and the air flow outlet; and
a vent channel having a vent gas inlet that is fluidically connected to the air flow channel; and
an air flow source, the air flow source, based on detecting thermal propagation of the prismatic battery assembly, directing air flow from the air flow inlet along the air flow channel and out the air flow outlet, the air flow drawing heated vent gasses from the vent gas inlet of the vent channel and away from the prismatic battery assembly.

14. The vehicle of claim 13, wherein the air flow source includes at least one selected from the group consisting of i) an air conditioning blower of a heating, ventilation and air conditioning (HVAC) system of a vehicle that provides cooled air flow to the prismatic battery assembly, and ii) an air flow compressor that provides ambient air flow to the prismatic battery assembly.

15. The vehicle of claim 13, wherein the air flow source is disposed upstream of the air flow inlet and directs the air flow into the air flow inlet.

16. The vehicle of claim 13, wherein the air flow source is disposed downstream of the air flow outlet and draws the air flow through the air flow outlet.

17. A prismatic battery assembly comprising:
an enclosure having a first end, a second end opposite the first end, a first side wall extending between the first end and the second end, and a second side wall opposite the first side wall and extending between the first end and the second end;
an air flow inlet disposed at the first side wall;
an air flow outlet disposed at the second side wall;
an air flow channel extending within the enclosure between the air flow inlet and the air flow outlet; and
a vent channel having a vent gas inlet that is fluidically connected to the air flow channel, wherein, based on detecting thermal propagation of the prismatic battery assembly, an air flow source directs air flow from the air flow inlet along the air flow channel and out the air flow outlet, the air flow drawing heated vent gasses from the vent gas inlet of the vent channel and away from the prismatic battery assembly.

18. The prismatic battery assembly of claim 17, wherein the air flow source includes at least one selected from the group consisting of i) an air conditioning blower of a heating, ventilation and air conditioning (HVAC) system of a vehicle that provides cooled air flow to the prismatic battery assembly, and ii) an air flow compressor that provides ambient air flow to the prismatic battery assembly.

19. The prismatic battery assembly of claim 17, wherein the air flow source is disposed upstream of the air flow inlet and directs the air flow into the air flow inlet.

20. The prismatic battery assembly of claim 17, wherein the air flow source is disposed downstream of the air flow outlet and draws the air flow through the air flow outlet.
